(19) United States
(12) Patent Application Publication
(10) Pub. No.: US 2012/0218142 A1
(43) Pub. Date: Aug. 30, 2012

(54) Reporting of Last Acquired Position During Gap of Satellite Reception for GNSS Systems

(75) Inventor: Maxime Leclercq, Encinitas, CA (US)

(73) Assignee: Maxlinear, Inc., Carlsbad, CA (US)

(21) Appl. No.: 13/219,511

(22) Filed: Aug. 26, 2011

Related U.S. Application Data
(60) Provisional application No. 61/377,425, filed on Aug. 26, 2010.

(51) Int. Cl. G01S 19/47; G01S 19/45; G01S 19/42

(52) U.S. Cl. 342/357.3; 342/357.25; 342/357.28

(57) ABSTRACT

A GNSS receiver includes a radio frequency module and an antenna for acquiring and tracking signals from various satellites and demodulating them to an intermediate frequency or a baseband signal. The receiver also includes a processing unit for processing the demodulated signals to obtain a first position, velocity, and time (PVT fix) data and displays the data to a user. The receiver may include a memory unit for storing the obtained PVT fix. The receiver may further include one or more sensors for detecting a motion of the receiver and provide an index to the processing unit that determines a next position of the receiver based on the index during a coverage gap. The one or more sensors may include an accelerometer, a compass, or a combination thereof.

### CROSS-REFERENCES TO RELATED APPLICATIONS

The present application claims benefit under 35 U.S.C. 119(e) of U.S. provisional application No. 61/377,425, filed Aug. 26, 2010, entitled “Reporting of Last Acquired Position During Gap of Satellite Reception for GNSS Systems”, the content of which is incorporated by reference in its entirety.

The present application is related to and herein incorporates by reference the entire content of application Ser. No. 13/218,383, filed Aug. 25, 2011, entitled “Dynamic Sleep Time Calculation for GNSS Receiver”.

### BACKGROUND OF THE INVENTION

Embodiments of the present invention relate to the field of Global Navigation Satellite Systems (GNSS), and more particularly, to techniques to a system and method for reporting a position of a GNSS receiver to a user during a coverage gap where the GNSS receiver does not receive satellite signals.

A GNSS receiver may provide several modes of operation. The most common mode is tracking during which the receiver receives satellite information and calculates time and position (“PVT” Position Velocity and Time). The position (“PVT fix”) is reported to the user typically at fixed time intervals called the rate of update. A positioning application uses this information for a given purpose such as mapping, asset tracking, and the like.

During the tracking mode (that could also be “intermittent” tracking for which the receiver tracks satellites for a small period of time and goes to sleep until the next PVT has to be reported to the user), the receiver may experience gaps of coverage where information sent by satellites cannot be demodulated. Coverage gaps can be from several sources such as entering a building or a tunnel, going through a deep urban or natural canyon, atmospheric conditions, and the like. During these coverage gaps, the position cannot be calculated and the user is typically reported with an error.

It is therefore a need to provide a GNSS system and method that is capable of providing a position and velocity to a user even during a coverage gap (i.e., when the GNSS receiver loses contact with or cannot demodulate signals from the satellites).

### BRIEF SUMMARY OF THE INVENTION

In accordance with embodiments of the present invention, a GNSS receiver comprises a radio frequency module including an antenna configured to acquire and track signals from various satellites and demodulate them to an intermediate frequency or a baseband signal. The receiver also includes a processing unit for processing the demodulated signals to obtain a first position, velocity, and time (PVT fix) information and provide the information to a user. The receiver may include a memory unit for storing the obtained PVT information. The receiver may further include one or more sensor elements for detecting a motion of the receiver and provide an index to the processing unit that determines a next position of the receiver based on the index during a coverage gap. In an embodiment, the one or more sensor elements may comprise an accelerometer, a compass, or a combination thereof. In an embodiment, the compass may provide travel direction data to the processing unit. The one or more sensor elements may provide acceleration data that is associated with the travel direction data and they may be time-indexed with the first position.

Embodiments of the present invention also provide a method that employs a global navigation satellite system receiver and a sensor to determine a position of the receiver during a coverage gap of satellites. The method includes receiving satellite signals and obtaining a first position of the receiver in response to the received satellite signals and storing the first position in a memory. The method further includes detecting a motion of the receiver by the sensor and obtaining an index in response to the detected motion. In addition, the method includes calculating a second position of the receiver during a coverage gap using the index and based on the first position and displaying the second position to a user.

Embodiments of the present invention have advantages over prior art techniques by delivering position information to a user even when the user enters areas that do not have line-of-sight to the available satellites, e.g., when the user is in a tunnel, in a building, or in dense urban areas with high rises, or in canyons.

### BRIEF DESCRIPTION OF THE DRAWINGS

Preferred embodiments of the present invention are described below, by way of example, with reference to the accompanying drawings, in which:

FIG. 1 is a block diagram illustrating a GNSS receiver according to an embodiment of the present invention;

FIG. 2 is a block diagram illustrating a GNSS system for estimating a position during a coverage gap according to an embodiment of the present invention; and

FIG. 3 is a flowchart diagram of a method for determining a position using a GNSS receiver having a motion sensor during coverage gap according to an embodiment of the present invention.

### DETAILED DESCRIPTION OF THE INVENTION

Embodiments of the present invention relate to an apparatus and method for determining a position and velocity of a GNSS receiver equipped with a motion sensor. When the receiver has direct line-of-sight to an adequate number of satellites, it calculates the position, velocity, and time (referred to as “PVT fixes”) information and periodically stores the information in a memory. The information may be displayed to a user.

A GNSS receiver includes a number of modules such as an antenna, an RF module, a processing unit, an input port, and a display. The RF module receives satellites signals through the antenna and demodulates them prior to outputting them to the processing unit.

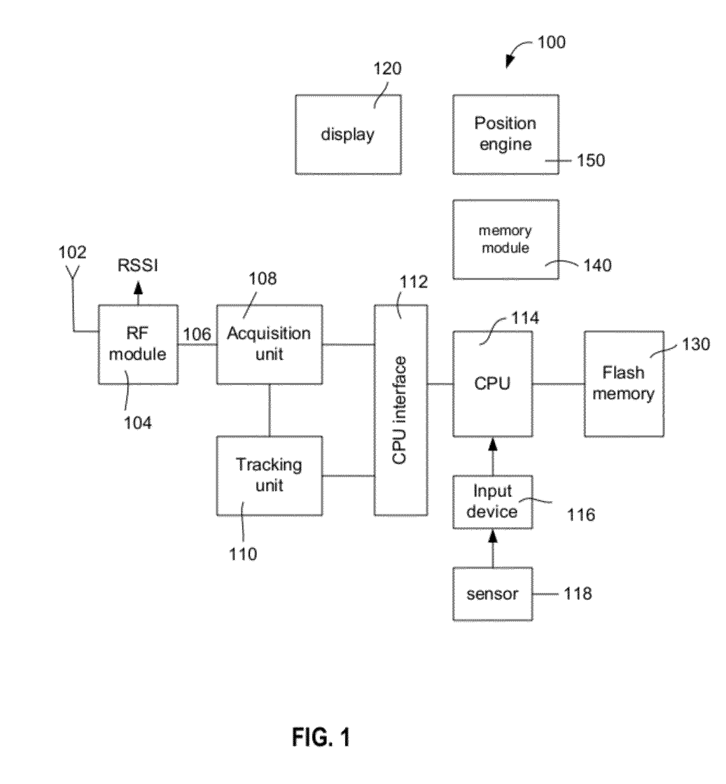

FIG. 1 is a block diagram illustrating a GNSS receiver 100 according to an embodiment of the present invention. Receiver 100 includes an antenna 102 for receiving GNSS satellite signals, a radio frequency (RF) module 104 coupled to the antenna 102 for downconverting the received signals to an intermediate frequency or a baseband signal 106. Baseband signal 106 is provided to an acquisition unit 108 and a tracking unit 110 that provide the tracked and acquired satellite signals to a CPU 114 via a CPU interface unit 112 for demodulation. The GNSS receiver calculates its position, velocity, and time information from the demodulated signals. The receiver measures its velocity with respect to that of a satellite by measuring the Doppler shift of the signals received from the satellite. Using an ephemeris and almanac, the position of the satellite are precisely known. The receiver can also determine its travel direction by interpolating its last known position. However, the position, velocity and time information determined by the receiver may not always be available due to coverage gap caused by loss of sight of the satellites when the receiver enters a building, a tunnel, or in dense urban areas.

The GNSS receiver also includes an input device 116 for receiving input data provided by a user or by a sensor 118. Sensor 118 can be, for example, a 2D/3D accelerometer, a motion detector, a speedometer, and the like. The receiver includes an output device 120 for providing position information to a user. In an embodiment, output device 120 may be an LCD display for displaying position, velocity, and time information to a user. An optional flash memory 130 coupled to the CPU may provide instructions and data to operate the CPU including the acquisition and tracking units. In an embodiment, the execution program codes and data for the operation of the receiver may be stored in a ROM, EPROM, EEPROM and the like that are embedded in the CPU. The tracking and acquisition units may track the code and carriers of the received satellite signals and determine the pseudo range of the receiver to the satellites and the offset of the receiver's clock from the satellite time reference. The pseudo range measurements and navigation data from at least four satellites are used to compute a three dimensional position and velocity fix. The CPU computes together with the acquisition and tracking units and a position engine 150 C/A codes and tracking loops, pseudo range measurements, acquisition and storage of almanac and ephemeris data broadcasted by the satellites. The obtained data including the position and velocity of the receiver is then stored in registers embedded in the CPU or in a memory module 140.

The GNSS receiver may provide several modes of operation. The most common mode is tracking during which the receiver receives satellite information and calculates time and position (“PVT” Position Velocity and Time). The position (“PVT fix”) is reported to the user typically at fixed time intervals called the rate of update. A positioning application uses this information for a given purpose such as mapping, asset tracking, and the like.

During the tracking mode (that could also be “intermittent” tracking for which the receiver tracks satellites for a small period of time and goes to sleep until the next PVT has to be reported to the user), the receiver may experience gaps of coverage where information sent by satellites cannot be received or demodulated. Coverage gaps can be from several sources such as entering a building or a tunnel, going through a deep urban or natural canyon, atmospheric conditions, and the like. During these coverage gaps, the position cannot be calculated and the user is typically reported with an error according to conventional art.

Embodiments of the present invention send the user the last calculated PVT or a derivative of the last calculated PVT when a position needs to be reported to the user during a coverage gap (triggered by the rate of update or a fix request from the user or the system). Referring to FIG. 1, sensor 118 may be an accelerometer that provides acceleration data that is time-indexed with the time information that is obtained together with the position and velocity data while the receiver has contact with the satellites and receives GNSS signals therefrom. In an embodiment, the receiver may include more than one accelerometer for obtaining more than one acceleration coordinate such as x, y, and z, where x and y provide an acceleration data vector in the horizontal direction of the receiver travel path, and z provides an acceleration vector for the vertical path. By using more than one accelerometer, a multi-dimensional travel path can be created. The data vectors can be time-indexed either with the time information obtained from the satellites or from an internal reference clock to generate indexed velocity and position data. The indexed velocity and position data can further be compared and adjusted (calibrated) with those obtained from the satellites.

An accuracy index can thus be created for the sensor. In an embodiment, sensor 118 may optionally include a compass that provides directional information to the receiver. In an embodiment, the compass can be a digital compass that determines direction relative to the Earth's magnetic poles and provides the information in digital format to the processing unit. The

CPU may include algorithms that calculates the receiver travel speed and direction based on the measured data of the accelerometer and the compass and compare the measured acceleration data of the accelerometer and the directional data of the compass to create an accuracy index of the receiver speed and directional. As the receiver moves away from the last known position into an area that satellite signals cannot be received or demodulated, the receiver can determine its new position based on its last known position and the accuracy index. In another embodiment, the sensor may include a speedometer that provides velocity information to the receiver.

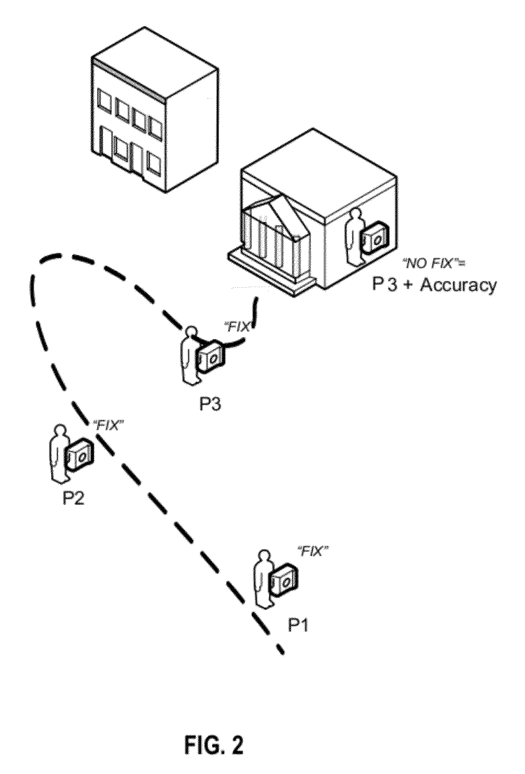

Referring now to FIG. 2, a user is shown to be equipped with a digital camera having a built-in receiver described above. The receiver (the camera) has line-of-sight or can receive signals from an adequate number of GNSS satellites in position P1, P2, and P3, where the PVT fix can be obtained. In an embodiment, the receiver is at a position where satellite signals can be received and demodulated. The position will be stored in a memory. As the user enters a building where the satellite signals cannot be received or demodulated (i.e., a coverage gap), the new position will be updated based on the previous position using an accuracy index. The previous position is stored in a memory. In an embodiment, the accuracy index may be calculated from an acceleration vector obtained from one or more accelerator sensors, a velocity vector from a previous PVT measurement before entering the coverage gap, a velocity from a speedometer, directional data from a compass, or a combination thereof as described above. In another embodiment, the accuracy index may be calculated from the velocity of the user at the time of the last known position (i.e., time associated with position P3 before the user enters the building) and the time elapsed from the last known position to the new position being estimated (the unknown position). The greater is the velocity and the time elapsed between the last known and the unknown position, the smaller is the accuracy of the estimated position relative to the real position of the user. In some embodiments, one or more accelerometers may be used to determine the acceleration of the user so as to improve the accuracy of the estimated position. While FIG. 2 shows a specific embodiment of the present invention that provides photo tagging for a camera, it should be understood that the present invention may be employed to provide positions for vehicles that are in dense urban areas or canyons when satellite signals cannot be received.

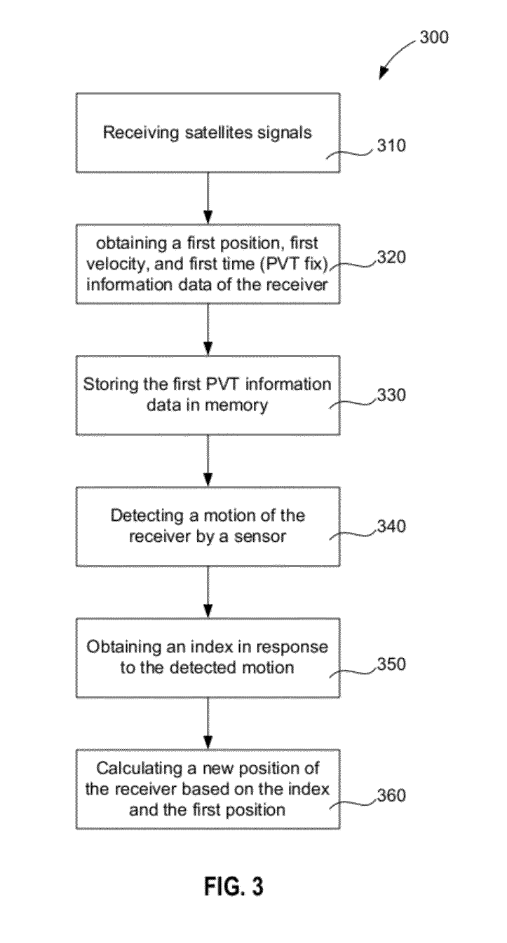

FIG. 3 shows a process 300 of calculating a position of a GNSS receiver during a coverage gap according to an embodiment of the present invention. Process 300 starts with the reception of satellite signals by the GNSS receiver as shown in FIG. 1. The satellite signals are acquired using the antenna and downconverted to a convenient intermediate frequency or baseband signal for a processing unit (CPU) for demodulation (step 310). The processing unit processes the baseband signal to obtain the first position, velocity and time (PVT fix) information data (step 320) and stores the PVT information data in a memory unit 140 as shown in FIG. 1 (step 330). A motion of the receiver is detected by a sensor 118 (step 340). As described previously, the sensor can be one or more accelerometers, a digital compass, or a combination thereof to provide acceleration data in x, y, z coordinates of the receiver. In an embodiment, the acceleration data are time-indexed with the first position and can provide velocity related to the directional vectors formed by a combination of the x, y, and z coordinates. In an embodiment, the time-indexed position and velocity obtained from the sensor can be calibrated using the PVT fix obtained in step 320. The time-indexed velocity and directional vectors form an index that will be used by the processing unit to calculated a new position when the receiver enters an area that does not receive satellite signals (step 360).

The embodiments of the present invention have been presented for the purposes of illustration and description. They are not intended to be restrictive. Many embodiments will be apparent to those of skill in the art upon reviewing the above description. The scope of the invention should, therefore, be determined not with reference to the above description, but instead should be determined with reference to the appended claims.

What is claimed is:

1. A GNSS receiver comprising:
a radio frequency module configured to receive satellite signals,
a processing unit configured to:
compute a first position of the receiver based on the received satellite signals;
obtain an index associated with the first position of the receiver; and
estimate a second position of the receiver in response to the index.

2. The GNSS receiver of claim 1 further comprising a sensor configured to enhance an accuracy to the index.

3. The GNSS receiver of claim 2, wherein the sensor comprises an accelerometer.

4. The GNSS receiver of claim 1 further comprising a digital compass configured to provide a travel direction to the receiver.

5. The GNSS receiver of claim 1, wherein the index comprises acceleration data measured along a travel direction of the receiver.

6. The GNSS receiver of claim 5, wherein the acceleration data are time-indexed with the first position and transformed to a velocity by the processing unit.

7. The GNSS receiver of claim 1, wherein the index is defined by a velocity and a time elapsed between the first position and the second position.

8. A method employing global navigation satellite system (GNSS) and a sensor to estimate a position of a GNSS receiver in a coverage gap, the method comprising:
receiving satellite signals by the receiver;
obtaining a first position of the receiver in response to the received satellite signals;
storing the obtained first position in a memory;
detecting a motion of the receiver in reference to the first position;
obtaining an index based on the detected motion; and
calculating a second position of the receiver during a coverage gap using the index and the first position.

9. The method of claim 8 further comprising:
determining a travel direction of the receiver using a digital compass.

10. The method of claim 8, wherein the motion comprises acceleration data that are time-indexed in relation to the first position.

11. The method of claim 8 further comprising:
displaying the second position of the receiver to a user at a variable time interval.

12. The method of claim 8, wherein the variable time interval is a function of a detected motion.

13. The method of claim 8, wherein the detecting a motion comprises the use of an accelerometer.

14. The method of claim 8, wherein the index is associated with a velocity and a time elapsed between the first position and the second position.
